(19) United States
(12) Patent Application Publication
(10) Pub. No.: US 2012/0096089 A1
(43) Pub. Date: Apr. 19, 2012

(54) CURBSYD™: A MOBILE AND WEB-BASED COMMUNITY FOR PROVIDING REAL-TIME, EXPERT CONSULTATION, AND ANSWERS TO SPECIFIC CLINICAL QUESTIONS, USING ARTIFICIAL INTELLIGENCE, AND CROWD-SOURCING TECHNOLOGIES

(76) Inventors: David Barash, Concord, MA (US); Norman A. Paradis, San Marcos, CA (US)

(21) Appl. No.: 13/273,878

(22) Filed: Oct. 14, 2011

Related U.S. Application Data
(60) Provisional application No. 61/393,088, filed on Oct. 14, 2010.

(51) Int. Cl. G06F 15/16

(52) U.S. Cl. 709/204

(57) ABSTRACT

A smart electronic communications network comprised of clinicians and experts designed for the purpose of answering diagnostic and clinical questions and queries posed by subscribers and participants in of the network.

### REFERENCE TO PENDING PRIOR PATENT APPLICATION

This patent application claims benefit of pending prior U.S. Provisional Patent Application Ser. No. 61/393,088, filed Oct. 14, 2010 by David Barash for CURBSYD™: A MOBILE AND WEB-BASED COMMUNITY FOR REAL-TIME MEDICAL CONSULTATION AND ADVICE (Attorney's Docket No. BARASH-3 PROV), which patent application is hereby incorporated herein by reference.

### FIELD OF THE INVENTION

This invention relates to electronic communication networks in general, and more particularly to electronic communication networks for providing expert advice to participants.

### BACKGROUND OF THE INVENTION

In the current healthcare delivery system, clinicians have several options when faced with the need to obtain clinical information, expertise, or consultation. The best known and oldest source of information is a textbook. However, in order for the clinician to use a textbook, the required book or resource needs to be in the practitioner's office or at their work site, or in their local work or personal library, at the time that they need to access the specific information sought. Furthermore, the time cycle for producing textbooks is quite long and much of the information is, of necessity, out of date by the time of publication.

With the introduction of the Internet, cellular technology, wireless communications, personal computers and mobile devices, physicians now have the ability to access information online in an easy and inexpensive manner. Many medical textbooks and journals are now accessible online electronically. This enables near real-time access to information globally.

Medical practitioners can also consult peer-reviewed medical literature electronically. However, this again requires that the practitioner be able to access such literature immediately at the time that the information is required, and the medical literature may also be out of date by the time that peer-review and publication is completed.

A second option for physician consultation is direct contact with a colleague or specialist in the required field. More particularly, physicians can: (1) call colleagues that they know personally or professionally, (2) contact an expert in a particular field, or (3) access a referral network to contact the required consultant. This process can be time-consuming and requires that the physician have a robust network in order to be able to identify and contact the appropriate consultant. Specific consultants and experts may not provide the best available answer to specific questions. Furthermore, the timing of such consultation may not match with the timing for which the consultation is required. By way of example but not limitation, in the emergency department, a physician may need consultation in the middle of the night when most consultants will not be available or for whom it would be inconvenient to be disturbed.

A third option for consultation is the utilization of prepared online services (such as Up-To-Date™) that consolidate textbook information, clinical literature and the expertise of the authors in order to help physicians research required information for patient care. In each of these cases, the physician is limited to their particular access capabilities, including knowledge of such services and subscription rights.

In each of the above circumstances, the data that the physician accesses is limited to the individual responses that they obtain, either from printed or online materials or from the consultants who are contacted. These sources also tend not to be real-time and tend not to be up-to-date.

The Internet and communications on the Internet, in particular with Web 2.0, provide extraordinary capability for communication, both in terms of capacity and speed of communications. There has been a dramatic growth in the capability of text messaging, video messaging and other multimedia communications. This robust capability is just starting to be appreciated by the healthcare industry.

Simultaneously, services such as Twitter™ and Facebook™ have enabled the growth of social networks to support communications for entertainment and professional purposes. Some social networks are open to all potential subscribers. Other social networks are restricted to specific types or categories of subscribers. One example of a closed social network is Sermo™ for physicians.

In addition to the foregoing, it has been well documented that groups are often capable of accurately predicting the most correct answer to certain types of questions, while individuals may have only limited capacity to answer certain questions. While individual guessing or estimates can be quite variable, groups can often collectively predict the correct answer to a problem (or at least get very close to the correct answer to a problem). This phenomenon has been described in the recent book “The Wisdom of Crowds: Why the Many Are Smarter Than the Few and How Collective Wisdom Shapes Business, Economies, Societies and Nations” (James Surowiecki). To date, this “wisdom of crowds” has not been utilized by the medical community.

In addition, the capability for search engines to search for key words within documents or across the entire Internet has greatly expanded the capacity for data analytics and the consolidation of information in an easily readable, and easily analyzed, fashion. Software search engines can now identify key words and phrases, and key word or phrase characteristics, in order to identify the meaning of certain phrases.

The need for clinicians to obtain real-time answers or expertise while caring for patients, and the recent expansion of computing power and real-time global connectivity, empowers the present invention.

### SUMMARY OF THE INVENTION

The present invention provides a mobile and web-based community for providing real-time, expert consultation, and answers to specific clinical questions, using artificial intelligence, and crowd-sourcing technologies.

In one form of the present invention, there is provided a smart electronic communications network comprised of clinicians and experts designed for the purpose of answering diagnostic and clinical questions and queries posed by subscribers and participants in of the network.

In another form of the present invention, there is provided a method for providing a response to a query, the method comprising:

submitting the query to a system which is connected in real-time to a plurality of pre-qualified individuals;

pushing the submitted query to at least some of the pre-qualified individuals;

receiving individual responses from at least some of the pre-qualified individuals and aggregating the received individual responses into an aggregated response according to a pre-determined scheme; and

pushing the aggregated response to the originator of the query.

In another form of the present invention, there is provided apparatus for providing a response to a query, the apparatus comprising:

a system connected in real-time to a plurality of pre-qualified individuals;

means for permitting one of the pre-qualified individuals to submit a query to the system;

means for pushing the submitted query to at least some of the pre-qualified individuals;

means for receiving individual responses from at least some of the pre-qualified individuals and for aggregating the received individual responses into an aggregated response according to a predetermined scheme; and

means for pushing the aggregated response to the originator of the query.

In another form of the present invention, there is provided apparatus for providing a response to a query, the apparatus comprising:

a system connected in real-time to a plurality of pre-qualified individuals;

means for permitting one of the pre-qualified individuals to submit a query to the system; means for determining if an answer to the query already exists within the system's database and adding that answer as an option to the query provided to prequalified individuals;

means for receiving individual responses from at least some of the pre-qualified individuals and for aggregating the received individual responses into an aggregated response according to a predetermined scheme; and

means for pushing the aggregated response to the originator of the query.

In another form of the present invention, there is provided apparatus for providing a response to a query, the apparatus comprising:

a system connected in real-time to a plurality of pre-qualified individuals;

means for permitting one of the pre-qualified individuals to submit a query to the system;

means for pushing the submitted query to at least some of the pre-qualified individuals;

means for receiving individual responses from at least some of the pre-qualified and self identifying individuals and for aggregating the received individual responses into an aggregated response according to a predetermined scheme; and

utilizing machine learning, electronic crowd sourcing, or artificial intelligence, to prioritize among various answers, and

means for pushing the aggregated response to the originator of the query.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing the basic principle of the present invention;

FIG. 2 is a schematic view showing the response ranking engine of the present invention;

FIG. 3 is a schematic view showing an exemplary calculation for ranking responses in the present invention; and

FIG. 4 is a schematic view showing how the present invention provides expert information to a participant.

### DETAILED DESCRIPTION OF THE PREFERRED EMBODIMENTS

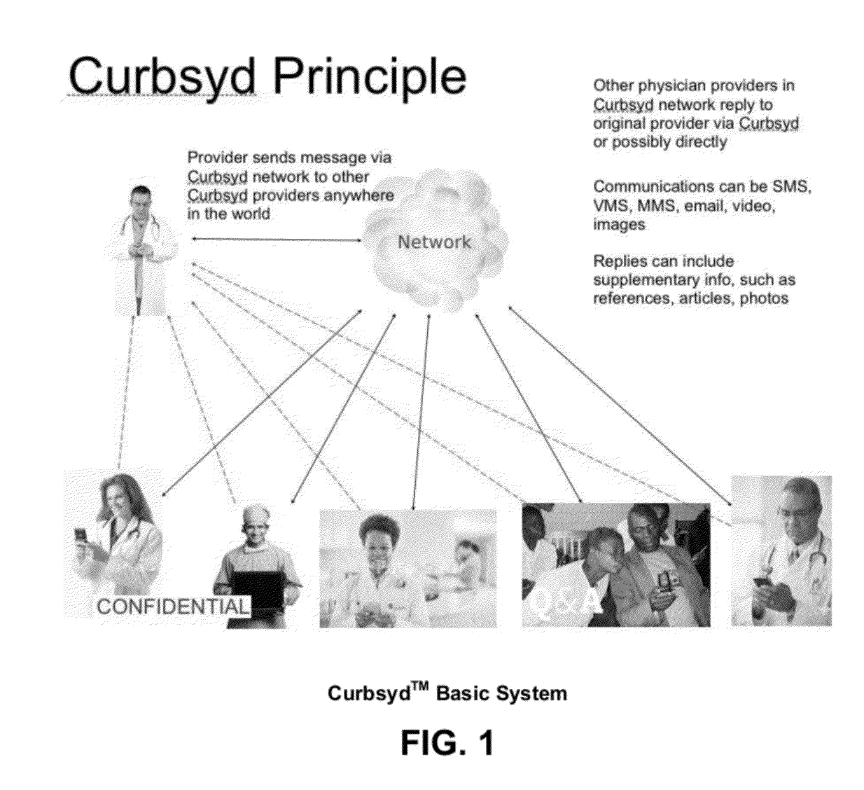

The present invention (also sometimes referred to herein as “the CurbSyd™ system” or “CurbSyd™”) allows a physician to simultaneously contact many providers and colleagues with potential expertise in real-time, at any time of day, from anywhere in the world. The present invention allows multiple respondents to reply to a physician inquiry with an immediate response to the inquiry, comment, or information posted. See FIG. 1.

The system can be based on either a secure private online community or an open access network. In the instance of a secure private online community, in order to become part of the community, an individual needs to present their credentials for validation by the system. The credentials are defined by the host (i.e., CurbSyd™). All members of the community must be credentialed, thus enabling professional communication with colleagues and thereby confirming a minimum level of expertise for the participants. The system is secure and encrypted so as to ensure viewing by only those authorized to view the content of the system. By way of example but not limitation, only licensed US physicians may be allowed to join the system. Such licensure is verified by the system and, subsequently, allows access to the system for the approved physician. Other categories of members, such as non-US physicians, other healthcare providers, business partners, etc., may also be granted global or limited access to the system, as determined by the system administrators.

In the CurbSyd™ system, a physician can access the system and post a query, e.g., from a mobile device, an Internet web site, etc. The query may then be sent to all members of the “community” (i.e., to all those participating in the CurbSyd™ system) or to only a select group of the members, e.g., those with special expertise. In some cases, a specific group of recipients may be selected, based on any criteria enabled by the system, e.g., medical specialty, geographic location, type of medical practice (rural, suburban, urban, academic/teaching, research-oriented, etc.), etc. The posted query may contain content such as text, voice, images, video, clinical data, etc. Alternatively, the clinician may post an alert message asking the recipients to go to a secure website to review the content of a posted query. The received alert message may also contain identifiers and security codes to allow the recipients to access the necessary information.

In a particular embodiment of the present invention, the system may utilize artificial intelligence to categorize the query and select a subset of community members (i.e., the best “experts”) who would receive the posted query.

The system may also utilize artificial intelligence for database searching to determine if a particular question has previously been posted and answered within the system, in which case the system may immediately push previous answers to the clinician posting the question.

When the appropriate community members (e.g., targeted experts and practitioners) receive the posted query (or alert message) via a mobile device, text message, E-mail, online posting, etc., the recipient has the option to “answer” the query (or respond to the alert message). This can be accomplished electronically by mobile device, text message, E-mail, online posting via a secure website, voice communications, video responses (such as Skype™ or other video services), etc. The types of information in the posted queries may include text questions, video, images, patient data and Internet links. Similarly, responses can include text, video, images, links, articles and other references. Responses or queries may also include an invitation to communicate directly, such as via telephone or over the Internet.

A key advantage of the CurbSyd™ system is that a physician using the system has the potential to receive responses from tens, hundreds, or thousands of potential respondents. This gives the physician an enormous database of information upon which they may treat their patient or do their analysis more effectively. The system may provide summary or advanced statistical descriptions and analysis of answers to the query. The system of the present invention allows a mobile device interface as well as a Web-based interface. In addition, communications may be text, voice or video, in either direction (i.e., query or response).

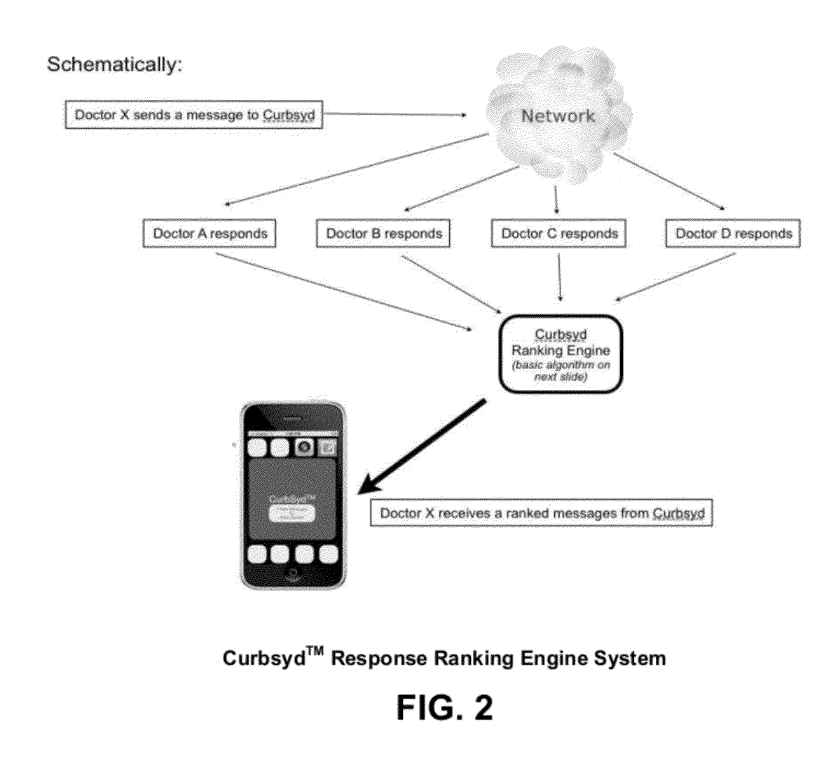

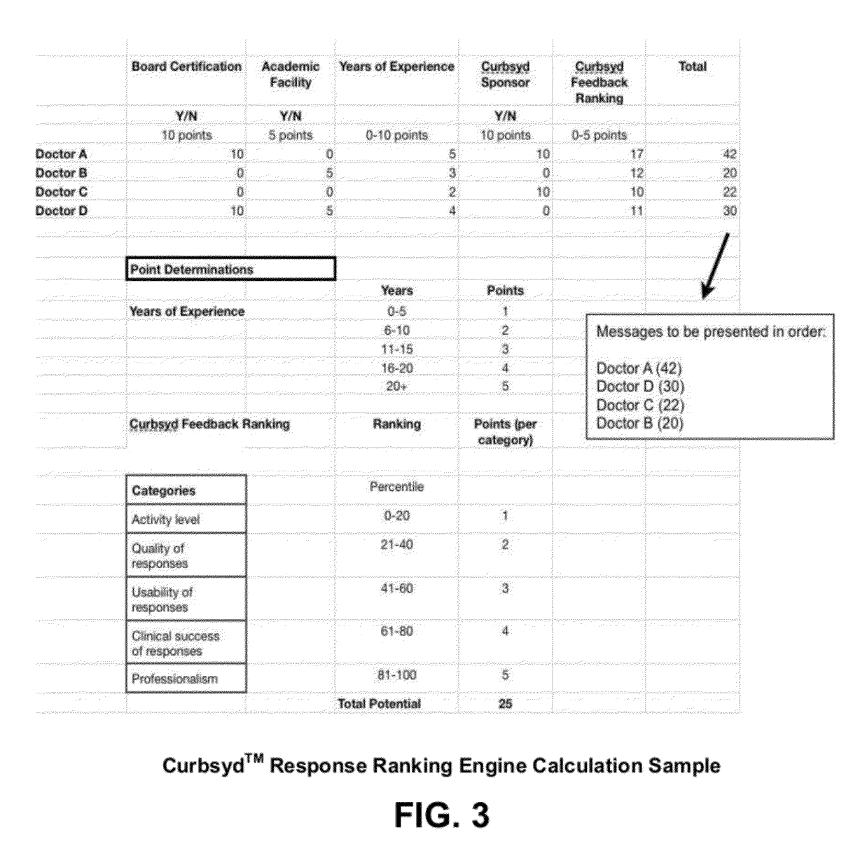

In one form of the present invention, the system may provide the inquiring physician with a specific ranking of the responses received. See FIG. 2. More particularly, in one form of the present invention, the participating physicians are required to complete a profile with a series of questions including training, schools attended, experience, specialty, publications, practice experience, etc. This information is used to algorithmically assign each network physician a ranking. See FIG. 3. Furthermore, in one form of the invention, each physician has the opportunity to improve their ranking by various types of interaction with the network. Such interactions may include the posing of questions, the answering of questions, direct feedback from other network physicians, etc. When a question is posed by a questioning physician, the responses that are received may be ranked by the system. This ranking may in turn impact the ranking of a respondent physician, depending on the quality of the response from the respondent physician. Responses can also be ranked based on the specialty of the responding physician. Or the responses can be ranked based on the geography of the responding physician. Other ranking criteria may be based upon the ongoing analysis of the system effectiveness and/or the personal preferences of each physician who is part of the network. Interactions or lack of interactions can also reduce a physician's ranking. The rank of physician respondents may be utilized by the system in prioritizing the display of answers to the posted query.

In one preferred form of the invention, the CurbSyd™ system is configured so that the physicians participating in the network can turn their connection to the system “on” and “off”, as they choose, and they can set certain criteria so as to filter the types of messages that the physician would like to receive. For example, an ophthalmologist may set his or her settings so that they are only receiving questions about ophthalmology (or an identified subspecialty of ophthalmology). Similarly, the physician may set their preferences for time of day, day of week and/or to block off certain times that the physician will not be available (or that they prefer to be available). Furthermore, the physician may set their geographic preferences (e.g., the physician may only receive queries from their continent, so as to minimize the likelihood of being awoken during the middle of their night).

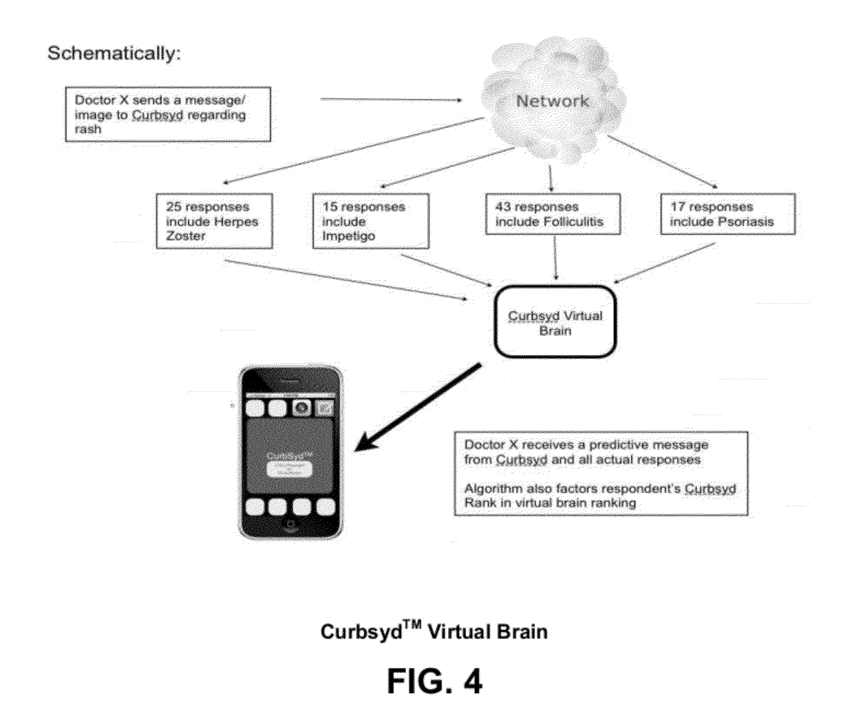

Another unique element of the system is the provision of a data engine which intelligently parses responses and analyzes the responses so as to give the requesting physician a ranking of the specific potential answers. Artificial intelligence and crowd-sourcing technology may be utilized in such ranking. If the system identifies a pattern to the responses, the recipient is preferably notified of the pattern or ranking of the responses by message or by visual ranking. This “virtual brain” leverages the collective expertise of the responding physicians. See FIG. 4.

The system is preferably configured so as to identify and distinguish key phrases (e.g., “myocardial ischemia” and “not likely to be myocardial ischemia”) in order to ensure correct ranking and parsing of responding data.

The business model for the CurbSyd™ system includes several opportunities for revenue generation.

In one form of the invention, the system is configured to offer certain corporate subscribers blinded access to the flow of messaging traffic. These corporate subscribers are able to see the types of questions being asked and answered, and may be allowed to post messages to support clinical activities. For example, a publisher of medical journals may be allowed to scan messages (either manually or in an automated fashion) and may be allowed to post to the community suggested articles or chapters that could be helpful for the discussion. The corporate subscribers may be allowed to post their name and other (limited and approved) corporate data with the information, as a controlled form of advertisement.

In another form of the present invention, certain corporate or academic subscribers are allowed priority for messaging traffic. For example, a large academic or tertiary care facility or network may be allowed to purchase the rights to be the highest ranked respondent for all traffic within a certain geographic area. These geographies may be identified by the IP address of the originating questioners. In the another form of the present invention, the subscribing participant may purchase the rights for priority within certain specialties or areas of clinical practice. By way of example but not limitation, a bariatric surgeon may purchase the rights to all questions related to obesity, or an endocrinologist may purchase the rights to all (or a certain number of) questions related to thyroid disease or diabetes.

In another form of the present invention, the CurbSyd™ system is adapted to offer a “freemium” model in which certain services offered by the system are turned “on” or “off” depending upon whether the subscriber wishes to participate for free or to pay a fee for enhanced participation. In one form of the invention, a “free” version of the system allows the subscriber to receive all messages and all advertisements or solicitations. However, for a fee, the subscriber or member may choose to turn off advertising and solicitations and may choose which clinical messages they would like to receive. In this form of the invention, the subscriber/participant pays to customize their subscription.

In another form of the invention, the CurbSyd™ system is configured so that additional revenue and commerce may be generated by making the answering of a query into a transaction. The clinician hosting the query may pay for the content that is provided. The experts who respond may be paid according to the system's or recipient's evaluation of the quality of their response and its priority in the ranking of responses.

In another form of the present invention, other types of communities may be developed: consumer-patients, non-physician providers or healthcare workers (including nurses, pharmacists, physical therapists, etc.), etc. These groups can be “gated” to like subscribers, but communities may also be developed to allow interaction between select communities on a controlled and monitored basis.

It is also anticipated that the CurbSyd™ system may be configured for use by other types of professional groups (e.g., lawyers, accountants, architects, etc.) and/or to students, researchers, service providers (e.g., car mechanics, HVAC technicians, etc.), etc.

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. A smart electronic communications network comprised of clinicians and experts designed for the purpose of answering diagnostic and clinical questions and queries posed by subscribers and participants in of the network.

2. A smart electronic communications network according to claim 1 wherein the responses to queries from other members of the community are prioritized using technologies such as machine learning, artificial intelligence, and crowd sourcing.

3. A smart electronic communications network according to claim 1 wherein the formation of answers to queries are constructed and prioritized using technologies such as machine learning, artificial intelligence, and crowd sourcing applied both real-time answers and a hierarchical database of previously answered queries.

4. A smart electronic communications network according to claim 1 wherein the members of the network can post questions to other members via mobile devices, such as cellular phones or tablets, or via the internet, such as via a website.

5. A smart electronic communications network according to claim 1 wherein the queries posted can include text, image, voice or video.

6. A smart electronic communications network according to claim 1 wherein the query comprises a practitioner sending a request from a computer or mobile device to the system, and storage of the inquiry, which may include text, video, voice, or images.

7. A smart electronic communications network according to claim 1 wherein there is transmission of the inquiry to other providers within the network on their respective computers, websites, email or mobile devices.

8. A smart electronic communications network according to claim 1 wherein responses from other practitioners within the network to the original inquirer may occur via a website, mobile device, text message, phone call, or video conference.

9. A smart electronic communications network according to claim 1 wherein the practitioners would join the network as a member.

10. A smart electronic communications network according to claim 1 wherein the participants self-determine which areas, based on specialty or other areas of interest, of the network to which they prefer to belong, what types of questions which they wish to review and to which they may respond, what days or times that they may be available for review and responses to questions.

11. A smart electronic communications network according to claim 1 wherein the practitioners would be able to temporarily set their criteria for receiving and responding to inquiries, either based on day, time, or area of interest.

12. A smart electronic communications network according to claim 1 wherein the practitioners are required to provide proof of professional status to ensure appropriate access to certain portions of the network and to receiving certain classes of queries.

13. A smart electronic communications network according to claim 1 wherein the host of the network would verify the professional status of the member utilizing both public, private subscription, and proprietary databases.

14. A smart electronic communications network according to claim 1 wherein the members would be ranked in order to enable other members to evaluate the source of any communication, including inquiries and replies to inquiries.

15. A smart electronic communications network according to claim 1 wherein members are required to provide certain specific types of information to enable the network to rank the members.

16. A smart electronic communications network according to claim 1 wherein the ranking criteria would include such background items as: education, years of professional work, and location and type of professional work.

17. A smart electronic communications network according to claim 1 wherein the ranking criteria would include such network history items as: number of inquiries, number of responses, timeliness of responses, accuracy and usefulness of responses, actual clinical application of responses, professionalism and other feedback as rated by other members, etc.

18. A smart electronic communications network according to claim 1 wherein responses to inquiries would be automatically ranked by the ranking of the respondents and presented to the original inquirer in rank order.

19. A smart electronic communications network according to claim 1 wherein the text in responses to inquiries would be automatically evaluated for key words or phrases, the key words or phrases would be processed by proprietary algorithms to determine which textual responses are likely to be more accurate or valid.

20. A smart electronic communications network according to claim 1 wherein the text in responses to key word or phrases would be ranked by both frequency of presence in responses and by factors associated with the ranking of the respondent using the referenced key word or phrase.

21. A smart electronic communications network according to claim 1 wherein the text in responses to key word or phrases would be analyzed by association with qualifying words, such as “not” or “likely”.

22. A smart electronic communications network according to claim 1 wherein the text in responses to key word or phrases would be parsed, analyzed or quantified in total to calculate a ranking of most likely correct crowd-sourced answers for the inquirer.

23. A smart electronic communications network according to claim 1 wherein artificial intelligence technology is utilized for the priority ranking of responses to queries.

24. A smart electronic communications network according to claim 1 wherein crowd sourcing technology is utilized, alone or in combination with other technologies, for the priority ranking of responses to queries.

25. A smart electronic communications network according to claim 1 wherein revenue will be augmented by offering key interested parties access to the information transmitted through the network.

26. A smart electronic communications network according to claim 1 wherein revenue will be augmented by offering key interested parties, such as publishers, access to review the specific content of messages, both inquiries and responses.

27. A smart electronic communications network according to claim 1 wherein revenue will be augmented by offering key interested parties, such as publishers, access to members in order to offer references to pertinent clinical information in either published journals or books, or websites.

28. A smart electronic communications network according to claim 1 wherein revenue will be augmented by offering key interested parties priority status in rankings for responses.

29. A smart electronic communications network according to claim 1 wherein revenue will be augmented by offering key interested parties, such as individual practitioners, practices, hospitals or other healthcare institutions, priority status in rankings for responses such that these interested parties will have responses ranked higher in the response listings.

30. A smart electronic communications network according to claim 1 wherein revenue will be augmented by offering members premium features of the network.

31. A smart electronic communications network according to claim 1 wherein revenue will be augmented by offering members content without advertising.

32. A smart electronic communications network according to claim 1 wherein revenue will be augmented by offering members content based on specific individualized criteria.

33. A smart electronic communications network according to claim 1 wherein revenue will be augmented by offering members content based on specific individualized criteria which would be comprised of: selected areas of content, such as specialty-specific areas, selected areas of content, such as industry information or practice management, premium levels of access to content, premium levels of access to certain members, ability to choice or accept content not available to basic services.

34. A smart electronic communications network according to claim 1 wherein revenue is generated by providing payments to experts providing answers and taking a portion of those payments as a transaction fee.

35. A smart electronic communications network according to claim 1 wherein revenue is generated by charging clinicians posing queries to the system, possibly modified based on the quality and utility of the answers provided to them.

36. A smart electronic communications network according to claim 1 wherein payments to experts providing answers is based on the system's evaluation of the quality of the content within their answer.

37. A smart electronic communications network according to claim 1 wherein answers provided for each query are stored for future use.

38. A smart electronic communications network according to claim 1 wherein the database of previously answered queries is prioritized based on utilization.

39. A smart electronic communications network according to claim 1 utilizing artificial intelligence and machine learning for database searching in an effort to determine if a particular question that has been posed has already been asked and answered within the system.

40. A smart electronic communications network according to claim 1 in which the database of previously answered queries is prioritized based in valuations provided by clinicians utilizing database query answers.

41. A method for providing a response to a query, the method comprising:
submitting the query to a system which is connected in real-time to a plurality of pre-qualified individuals;
pushing the submitted query to at least some of the pre-qualified individuals;
receiving individual responses from at least some of the pre-qualified individuals and aggregating the received individual responses into an aggregated response according to a pre-determined scheme; and
pushing the aggregated response to the originator of the query.

42. Apparatus for providing a response to a query, the apparatus comprising:
a system connected in real-time to a plurality of pre-qualified individuals;
means for permitting one of the pre-qualified individuals to submit a query to the system;
means for pushing the submitted query to at least some of the pre-qualified individuals;
means for receiving individual responses from at least some of the pre-qualified individuals and for aggregating the received individual responses into an aggregated response according to a predetermined scheme; and
means for pushing the aggregated response to the originator of the query.
